(19) United States
(12) Patent Application Publication
(10) Pub. No.: US 2025/0145093 A1
(43) Pub. Date: May 8, 2025

(54) WIRE HARNESS ROUTING STRUCTURE

(71) Applicant: YAZAKI CORPORATION, Tokyo (JP)

(72) Inventors: Mitsuhisa Sano, Makinohara-shi (JP); Taku Furuta, Makinohara-shi (JP); Kenichi Imou, Makinohara-shi (JP); Junya Kato, Makinohara-shi (JP); Hiroki Suganuma, Makinohara-shi (JP)

(21) Appl. No.: 18/927,799

(22) Filed: Oct. 25, 2024

(30) Foreign Application Priority Data
Nov. 7, 2023 (JP) 2023-190010

(51) Int. Cl. B60R 16/02; B60R 16/023

(52) U.S. Cl. CPC B60R 16/0215; B60R 16/0231

(57) ABSTRACT

A wire harness routing structure includes a flat routing member having flexibility and extending along a vehicle width direction, and a cover member having a sheet shape and including a back surface to which the flat routing member is fixed and a front surface opposite to the back surface, and the cover member is fixed to a vehicle body panel of a vehicle such that the flat routing member is sandwiched with respect to the vehicle body panel.

### CROSS-REFERENCE TO RELATED APPLICATION(S)

The present application claims priority to and incorporates by reference the entire contents of Japanese Patent Application No. 2023-190010 filed in Japan on Nov. 7, 2023.

### BACKGROUND OF THE INVENTION

### 1. Field of the Invention

The present invention relates to a wire harness routing structure.

### 2. Description of the Related Art

As a technique related to a conventional wire harness routing structure, for example, Japanese Patent Application Laid-open No. 2012-055105 discloses a wire harness routing structure including a flexible flat routing member, a protector for protecting the flat routing member, and a fixing member for fixing the protector to an attachment portion of a vehicle.

Meanwhile, with the wire harness routing structure described in Japanese Patent Application Laid-open No. 2012-055105 described above, for example, there is room for further improvement in terms of improvement in assemblability to a vehicle.

### SUMMARY OF THE INVENTION

The present invention has been made in view of the above circumstances, and an object is to provide a wire harness routing structure capable of improving assemblability to a vehicle.

In order to achieve the above mentioned object, a wire harness routing structure according to one aspect of the present invention includes a flat routing member that has flexibility; and a cover member to which the flat routing member is fixed, wherein the cover member is fixed to a vehicle body panel of a vehicle such that the flat routing member is sandwiched with respect to the vehicle body panel.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a vehicle to which a wire harness routing structure according to an embodiment is applied;

FIG. 2 is an exemplary cross-sectional view of the wire harness routing structure according to the embodiment;

FIG. 3 is an exemplary cross-sectional view of the wire harness routing structure according to the embodiment, and is a view of a state in which a flat routing member and a cover member are removed from a vehicle body panel;

FIG. 4 is an exemplary perspective view of the flat routing member of the wire harness routing structure according to the embodiment;

FIG. 5 is an exemplary perspective view illustrating a connection structure between a connector of the wire harness routing structure according to the embodiment and a control device;

FIG. 6 is an exemplary cross-sectional view illustrating the connection structure between the connector of the wire harness routing structure according to the embodiment and the control device; and

FIG. 7 is an exemplary plan view of the flat routing member of the wire harness routing structure according to the embodiment.

### DETAILED DESCRIPTION OF THE PREFERRED EMBODIMENTS

Hereinafter, an embodiment according to the present invention will be described in detail with reference to the drawings. Note that this invention is not limited to the embodiment described below. In addition, the constituent elements in the embodiment described below include those that can be easily replaced by those skilled in the art or those that are substantially the same. Note that, in the present specification, ordinal numbers are used only to distinguish components, members, parts, positions, directions, and the like, and do not indicate order or priority.

### EMBODIMENT

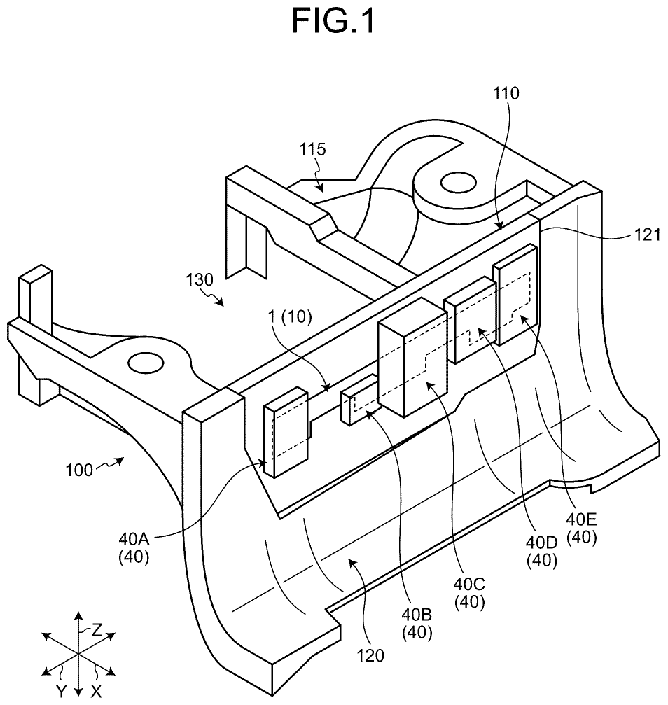

FIG. 1 is a perspective view of a vehicle 100 to which a wire harness routing structure 1 according to an embodiment is applied. The wire harness routing structure 1 of the present embodiment illustrated in FIG. 1 is applied to the vehicle 100, and is used for power supply and signal communication by connecting devices mounted on the vehicle 100. The wire harness routing structure 1 of the present embodiment is provided, for example, in a vehicle body panel 110 constituting at least a part of a dash panel 120. The dash panel 120 is a partition wall that partitions an engine room 130 and a vehicle interior (cabin) of the vehicle 100, and constitutes a structural member (frame member) of the vehicle 100.

Here, in the present embodiment, the dash panel 120 is integrally molded with, for example, a peripheral panel 115 and the like of the engine room 130. As a result, rigidity and strength of the dash panel 120 can be enhanced, and eventually the vehicle body panel 110 can be formed of a resin molded article. That is, in the present embodiment, the vehicle body panel 110 is formed of a component separate from the dash panel 120 made of metal. The vehicle body panel 110 is installed, for example, in a recess 121 formed in the dash panel 120 and is disposed inside an instrument panel of the vehicle 100.

Note that, in the description below, among a first direction, a second direction, and a third direction intersecting one another, the first direction is referred to as a “vehicle front-rear direction X”, the second direction is referred to as a “vehicle width direction Y”, and the third direction is referred to as a “vehicle height direction Z”. Here, the vehicle front-rear direction X, the vehicle width direction Y, and the vehicle height direction Z are substantially orthogonal to one another. The vehicle front-rear direction X typically corresponds to the entire length direction of the vehicle 100, the stacking direction of the wire harness routing structure 1, and the like. The vehicle width direction Y typically corresponds to the entire width direction of the vehicle 100, the longitudinal direction (extending direction) of the wire harness routing structure 1, and the like. The vehicle height direction Z typically corresponds to the vehicle height direction of the vehicle 100, the lateral direction of the wire harness routing structure 1, and the like. Note that each direction used in the description below will be described as a direction in a state where the wire harness routing structure 1 is assembled to the vehicle 100 unless otherwise specified.

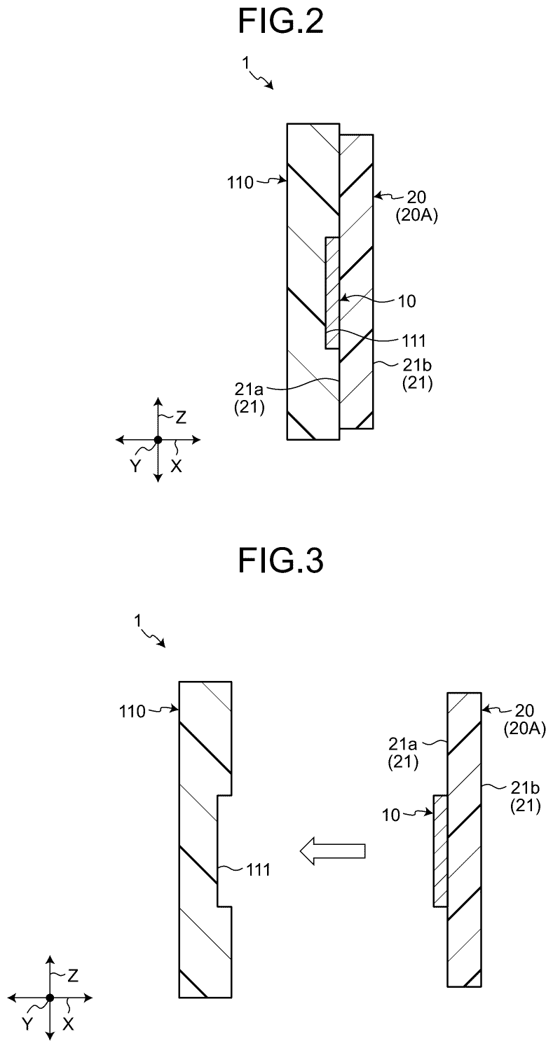

FIG. 2 is a cross-sectional view of the wire harness routing structure 1, and FIG. 3 is a cross-sectional view of the wire harness routing structure 1 and is a view of a state in which a flat routing member 10 and a cover member 20 are removed from the vehicle body panel 110. As illustrated in FIGS. 2 and 3, the wire harness routing structure 1 of the present embodiment includes, for example, a groove portion 111 formed in the vehicle body panel 110, the flat routing member 10, and the cover member 20.

The groove portion 111 is a recess formed in the vehicle body panel 110 described above, and extends along the vehicle width direction Y. The groove portion 111 is recessed from the inner surface of the vehicle body panel 110 toward the front side in the vehicle front-rear direction X and is opened toward the rear side in the vehicle front-rear direction X. The groove portion 111 has a shape along the outer diameter shape of the flat routing member 10, and the flat routing member 10 is accommodated and routed along the vehicle width direction Y so as to run in the groove portion 111. In the present embodiment, in a state where the flat routing member 10 is accommodated in the groove portion 111, a slight gap is provided between the groove portion 111 and the flat routing member 10.

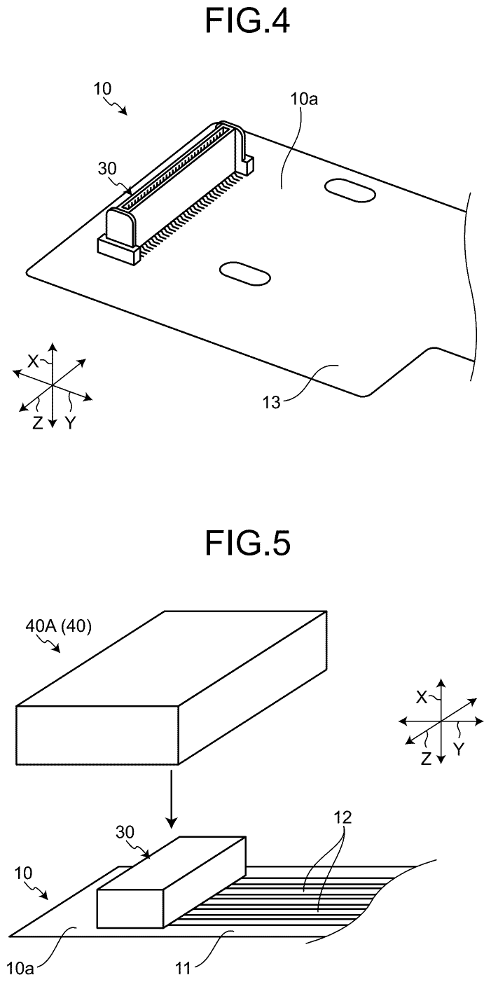

For example, the groove portion 111 integrally extends along the vehicle width direction Y so as to extend between a first ECU 40A (see FIG. 1) of a control device 40 provided at one end portion in the vehicle width direction Y and a second ECU 40E of the control device 40 provided at the other end portion in the vehicle width direction Y. In the present embodiment, the flat routing member 10 is provided with connectors 30 (see FIGS. 4 and 5) at both end portions 10a in the vehicle width direction Y. Then, the flat routing member 10 is connected to the first ECU 40A of the control device 40 via one connector 30, and is connected to the second ECU 40E of the control device 40 via the other connector 30.

Note that the first ECU 40A and the second ECU 40E here are typically zone ECUs that integrally control devices in a peripheral region (zone) of the vehicle body panel 110, but are not limited thereto. In addition, other ECUs 40B to 40D and the like of the control device 40 may be provided between the first ECU 40A and the second ECU 40E. Note that, in FIG. 1, the cover member 20 is not illustrated for convenience.

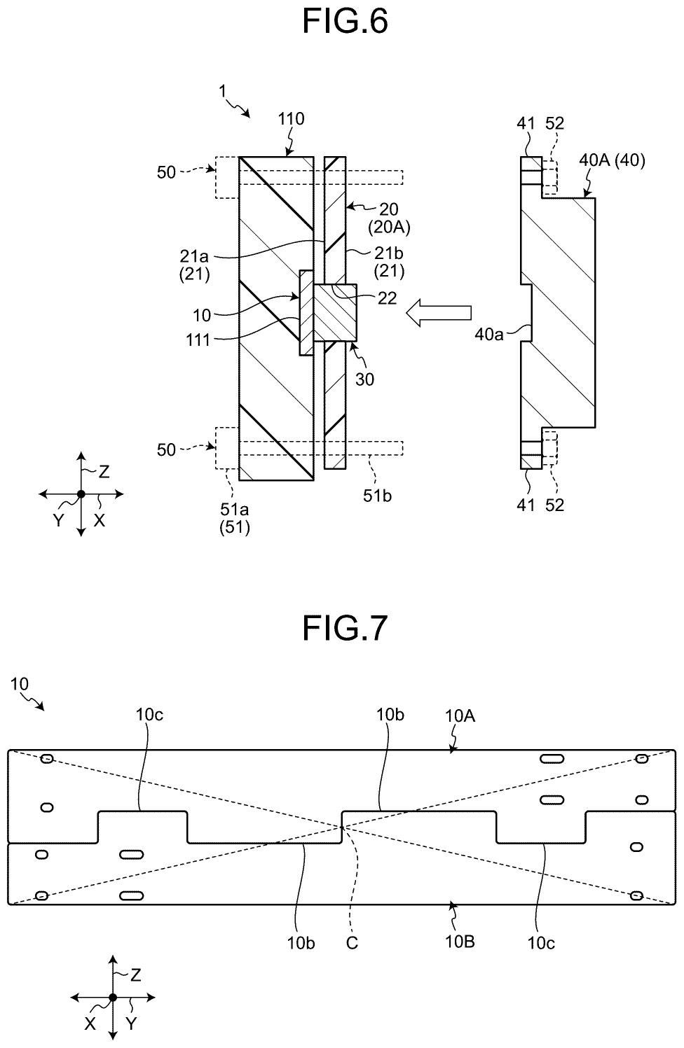

The flat routing member 10 is fixed to the cover member 20 (see FIGS. 2 and 3), and the cover member 20 covers the periphery of the flat routing member 10. The cover member 20 is configured to include, for example, a cover body 21 and through-holes 22 (see FIG. 6) to be described below provided at both end portions of the cover body 21 in the vehicle width direction Y. The cover body 21 is formed in a rectangular sheet shape (thin plate shape) horizontally elongated in the vehicle width direction Y. The length of the cover body 21 along the vehicle width direction Y is, for example, substantially the same as the length of the groove portion 111 and the flat routing member 10 along the vehicle width direction Y.

The cover body 21 has a back surface 21a facing the groove portion 111 of the vehicle body panel 110 and a front surface 21b facing a side opposite to the back surface 21a in the vehicle front-rear direction X. For example, the flat routing member 10 is fixed to the back surface 21a via an adhesive layer such as an adhesive or a double-sided tape. The width of the back surface 21a (cover body 21) along the vehicle height direction Z is set to be larger than the widths of the groove portion 111 and the flat routing member 10 along the vehicle height direction Z. That is, the back surface 21a is configured to include a portion overlapping a peripheral edge portion of the groove portion 111 in the vehicle body panel 110 in the vehicle front-rear direction X.

In addition, the cover body 21 includes, for example, a silencer 20A. The silencer 20A is, for example, a sound absorbing material formed of a felt body (nonwoven fabric) or the like, and has a silencing function of suppressing a sound of the engine room 130 outside the vehicle body panel 110 from entering the vehicle interior. The cover member 20 as the silencer 20A is fixed to the vehicle body panel 110 so as to sandwich the flat routing member 10 with respect to the vehicle body panel 110.

At this time, in the present embodiment, the flat routing member 10 is accommodated in the groove portion 111 formed in the vehicle body panel 110 in a state of being fixed to the cover member 20. The cover member 20 is fixed to the inner surface of the vehicle body panel 110 via, for example, an adhesive layer such as an adhesive or a double-sided tape, a fastening member, or the like. As described above, in the present embodiment, the flat routing member 10 is not directly fixed to the vehicle body panel 110, but is fixed to the vehicle body panel 110 via the cover member 20.

FIG. 4 is a perspective view of the flat routing member 10 of the wire harness routing structure 1. As illustrated in FIG. 4, the flat routing member 10 is a routing member constituting the wire harness, and is configured by, for example, a flexible printed circuit (FPC), flexible flat cable (FFC), or the like. The flat routing member 10 is a thin and flexible flat routing member. The flat routing member 10 is formed in a rectangular shape horizontally elongated in the vehicle width direction Y as a whole. The flat routing member 10 is configured to include, for example, a base film 11 (see FIG. 5), a wiring pattern 12, and a coverlay 13.

The base film 11 is a base material that is excellent in flexibility and defines the entire shape of the flat routing member 10. The base film 11 is formed of, for example, a polyimide resin or the like having excellent heat resistance. The wiring pattern 12 is, for example, stacked on a surface (mounting surface) of the base film 11 to constitute a plurality of conductor circuit portions (pattern layers). The wiring pattern 12 is formed of a conductive material such as a copper foil, and is printed as a printed circuit body on the surface of the base film 11. The coverlay 13 is stacked on the entire surface of the base film 11 via an adhesive, which is not illustrated, and functions as a protective layer for protecting the conductor circuit portion and the like of the wiring pattern 12.

In addition, the plurality of conductor circuit portions configured by the wiring pattern 12 can function as any circuit of, for example, a signal circuit, a signal GND circuit, a power ground circuit, and the like. The signal circuit is, for example, a circuit that transmits a communication signal between the control device 40 and in-vehicle devices such as various electronic devices in the vehicle 100. The signal GND circuit is a circuit that conducts between the in-vehicle devices in association with the signal circuit and adjusts a potential serving as a reference of a circuit operation between the in-vehicle devices. The power ground circuit is a circuit that grounds a power supply system of the in-vehicle devices.

FIG. 5 is a perspective view illustrating a connection structure between the connector 30 of the wire harness routing structure 1 and the control device 40, and FIG. 6 is a cross-sectional view illustrating a connection structure between the connector 30 of the wire harness routing structure 1 and the control device 40. As illustrated in FIGS. 5 and 6, in the present embodiment, the flat routing member 10 includes the connectors 30 at both end portions 10a in the vehicle width direction Y. Then, the cover member 20 is provided with through-holes 22 (see FIG. 6) through which the connectors 30 are exposed at both end portions in the vehicle width direction Y.

The through-hole 22 is an opening penetrating the cover member 20 along the vehicle front-rear direction X, and has a shape along the outer shape of the connector 30. The connector 30 is attached to the cover member 20 in a state of penetrating the through-hole 22, and protrudes toward the rear side (the control device 40 side) in the vehicle front-rear direction X. The connector 30 can be connected to, for example, a control device-side connector 40a of the control device 40.

Here, in the present embodiment, the connector 30 is fitted to the control device-side connector 40a depending on the fastening of the control device 40 to the vehicle body panel 110 by fastening members 50. Specifically, in the present embodiment, the fastening member 50 is configured to include bolts 51 and nuts 52, and the control device 40 is provided with flanges 41 in which through-holes through which the bolts 51 are inserted along the vehicle front-rear direction X are formed. For example, the bolt 51 is attached in a state where a head portion 51a is locked to the outer surface of the vehicle body panel 110 (surface opposite to the groove portion 111) and a shaft portion 51b penetrates the vehicle body panel 110 and the cover member 20.

Then, the bolt 51 protrudes from the vehicle body panel 110 toward the rear side (control device 40 side) in the vehicle front-rear direction X, and is fastened to the nut 52 in a state of being inserted into the through-hole formed in the flange 41 of the control device 40. As a result, the bolts 51 function as assist bolts at the time of fitting between the connector 30 and the control device-side connector 40a, and eventually, the fitting operation between the connector 30 and the control device-side connector 40a can be performed more easily or more smoothly. For example, a pair of fastening members 50 and a pair of flanges 41 are provided on both sides in the vehicle height direction Z so as to sandwich the connector 30 and the control device-side connector 40a.

FIG. 7 is a plan view of the flat routing member 10 of the wire harness routing structure 1. As illustrated in FIG. 7, in the present embodiment, the flat routing member 10 has, for example, a shape that is point-symmetrical each other in a state where a pair of the flat routing members faces each other. That is, the flat routing member 10 (hereinafter, may be referred to as a flat routing member 10A) of the present embodiment is manufactured at the same time as another flat routing member 10B in the manufacturing stage, and the pair of flat routing members 10A and 10B is mounted on different vehicles 100.

The pair of flat routing members 10A and 10B has, for example, a first protrusion portion 10b and a second protrusion portion 10c at end portions in the vehicle height direction Z. The amount of protrusion of the first protrusion portion 10b in the vehicle height direction Z is substantially the same as the amount of protrusion of the second protrusion portion 10c in the vehicle height direction Z. In addition, the lateral width of the first protrusion portion 10b along the vehicle width direction Y is larger than the lateral width of the second protrusion portion 10c along the vehicle width direction Y. The first protrusion portion 10b and the second protrusion portion 10c function as, for example, connection portions with devices such as the ECUs 40B to 40D described above.

Then, the pair of flat routing members 10A and 10B has a shape in which the first protrusion portion 10b and the second protrusion portion 10c of the flat routing member 10A and the first protrusion portion 10b and the second protrusion portion 10c of the flat routing member 10B overlap each other when rotated 180° about a symmetric point C. With this configuration, in the wire harness routing structure 1, for example, the yield at the time of manufacturing the flat routing member 10 can be improved, and eventually, the labor, cost, and the like required for manufacturing the wire harness routing structure 1 can be reduced.

As described above, the wire harness routing structure 1 of the present embodiment is configured to include the flat routing member 10. Therefore, the wire harness configured by the flat routing member 10 is reduced in weight as compared with a wire harness in which general various electrical wires are bundled. Here, in a case where the wire harness routing structure 1 described above is installed in the vehicle 100, the length of the wire harness is assumed to be about 1000 mm, and when all the wire harnesses having such a length are configured by electrical wires, the entire weight of the wire harnesses may increase. In this regard, according to the present embodiment, since the wire harness is configured to include the flat routing member 10, it is possible to support an increase in size of the wire harness while suppressing an increase in entire weight of the wire harness.

In addition, generally, a wire harness in which various electrical wires are bundled is manufactured manually by an operator. On the other hand, since the flat routing member 10 can be manufactured by automation, it is also possible to reduce the number of manufacturing steps of the wire harness by configuring the wire harness with the flat routing member 10. In addition, generally, a large wire harness in which various electrical wires are bundled has difficulty in transportation due in part to its weight. On the other hand, according to the present embodiment, the flat routing member 10 also has an advantage that, for example, the number of manufacturing days of the wire harness itself or the vehicle 100 using the wire harness is shortened, or the manufacturing place is hardly limited.

As described above, the wire harness routing structure 1 of the present embodiment includes the flat routing member 10 having flexibility and the cover member 20 to which the flat routing member 10 is fixed, and the cover member 20 is fixed to the vehicle body panel 110 of the vehicle 100 such that the flat routing member 10 is sandwiched with respect to the vehicle body panel 110. With this configuration, in the wire harness routing structure 1, for example, the flat routing member 10 constituting the wire harness can be assembled to the vehicle 100 by fixing the cover member 20 to which the flat routing member 10 is fixed to the vehicle body panel 110 such that the flat routing member 10 is sandwiched with respect to the vehicle body panel 110. As a result, the wire harness routing structure 1 can improve the assemblability to the vehicle 100.

In addition, in the wire harness routing structure 1 of the present embodiment, the cover member 20 includes the silencer 20A that suppresses a sound of the engine room 130 outside the vehicle body panel 110 from entering the vehicle interior. With this configuration, the wire harness routing structure 1 has an advantage that, for example, a desired silencing effect can be obtained by the silencer 20A, wear caused by interference between the silencer 20A and the flat routing member 10 can be suppressed, and eventually an exterior material of the flat routing member 10 can be unnecessary.

In addition, in the wire harness routing structure 1 of the present embodiment, the connectors 30 are provided at both end portions 10a (end portions) of the flat routing member 10, and the cover member 20 is provided with the through-holes 22 through which the connectors 30 are exposed. With this configuration, in the wire harness routing structure 1, for example, a central portion (main body portion) of the flat routing member 10 can be covered with the cover member 20 so as to be more reliably protected, and the connectors 30 provided at the both end portions 10a can be exposed through the through-holes 22 to be connected to devices such as the control device 40.

In addition, in the wire harness routing structure 1 of the present embodiment, the connector 30 can be connected to the control device-side connector 40a of the control device 40, and the connector 30 and the control device-side connector 40a are fitted depending on the fastening of the control device 40 to the vehicle body panel 110 by the fastening members 50. With this configuration, in the wire harness routing structure 1, for example, the fastening members 50 function as assist bolts at the time of fitting between the connector 30 and the control device-side connector 40a, and eventually, the fitting operation between the connector 30 and the control device-side connector 40a can be performed more easily or more smoothly.

In addition, in the wire harness routing structure 1 of the present embodiment, the flat routing member 10 has a shape that is point-symmetrical each other in a state where a pair of the flat routing members faces each other. With this configuration, in the wire harness routing structure 1, for example, the yield at the time of manufacturing the flat routing member 10 can be improved, and eventually, the labor, cost, and the like required for manufacturing the wire harness routing structure 1 can be reduced.

In addition, the wire harness routing structure 1 of the present embodiment includes the groove portion 111 formed in the vehicle body panel 110 and accommodating the flat routing member 10. With this configuration, the wire harness routing structure 1 can further improve the assemblability of the flat routing member 10 to the vehicle 100 by, for example, closing the groove portion 111 with the cover member 20 in a state where the flat routing member 10 is accommodated in the groove portion 111. In addition, for example, there is an advantage that the groove portion 111 can be relatively easily formed in the vehicle body panel 110 made of resin, wear caused by interference between the vehicle body panel 110 and the flat routing member 10 can be suppressed, and eventually an exterior material of the flat routing member 10 can be unnecessary.

Note that, in the present embodiment, the case where the groove portion 111 for accommodating the flat routing member 10 is formed in the vehicle body panel 110 has been exemplified, but it is not limited to this example, and for example, the groove portion 111 for accommodating the flat routing member 10 may not be provided in the vehicle body panel 110. In addition, in the present embodiment, the case where the cover member 20 includes the silencer 20A having a silencing function has been exemplified, but it is not limited to this example, and the cover member 20 may include, for example, a cover member 20 having no silencing function.

In addition, in the wire harness routing structure 1, for example, the vehicle body panel 110 itself having the groove portion 111 may constitute a part of the wire harness routing structure 1. That is, the wire harness routing structure 1 may be configured to include the vehicle body panel 110 (vehicle body panel 110 installed in recess 121 formed in dash panel 120 of vehicle 100) itself in addition to the flat routing member 10 and the cover member 20.

The embodiment of the present invention has been described above; however, the aforementioned embodiment is one example and is not intended to limit the scope of the invention. The above embodiment can be implemented in various other forms, and various omissions, substitutions, combinations, and changes can be made without departing from the gist of the invention. In addition, each configuration, shape, and other specifications (structure, type, direction, form, size, length, width, thickness, height, number, arrangement, position, material, etc.) can be changed as needed.

In a wire harness routing structure according to the present embodiment, a flat routing member constituting a wire harness can be assembled to a vehicle by fixing a cover member to which the flat routing member is fixed to a vehicle body panel of the vehicle such that the flat routing member is sandwiched with respect to the vehicle body panel. As a result, the effect that the wire harness routing structure can improve the assemblability to the vehicle is provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness routing structure comprising:
a flat routing member that has flexibility; and
a cover member to which the flat routing member is fixed, wherein
the cover member is fixed to a vehicle body panel of a vehicle such that the flat routing member is sandwiched with respect to the vehicle body panel.

2. The wire harness routing structure according to claim 1, wherein
the cover member includes a silencer that suppresses a sound of an engine room outside the vehicle body panel from entering a vehicle interior.

3. The wire harness routing structure according to claim 1, wherein
a connector is provided at an end portion of the flat routing member, and
the cover member is provided with a through-hole through which the connector is exposed.

4. The wire harness routing structure according to claim 2, wherein
a connector is provided at an end portion of the flat routing member, and
the cover member is provided with a through-hole through which the connector is exposed.

5. The wire harness routing structure according to claim 3, wherein
the connector is able to be connected to a control device-side connector of a control device, and
the connector and the control device-side connector are fitted depending on fastening of the control device to the vehicle body panel by a fastening member.

6. The wire harness routing structure according to claim 4, wherein
the connector is able to be connected to a control device-side connector of a control device, and
the connector and the control device-side connector are fitted depending on fastening of the control device to the vehicle body panel by a fastening member.

7. The wire harness routing structure according to claim 1, wherein
the flat routing member has a shape that is point-symmetrical each other in a state where a pair of the flat routing members faces each other.

8. The wire harness routing structure according to claim 2, wherein
the flat routing member has a shape that is point-symmetrical each other in a state where a pair of the flat routing members faces each other.

9. The wire harness routing structure according to claim 1, further comprising:
a groove portion that is formed in the vehicle body panel and accommodates the flat routing member.

10. The wire harness routing structure according to claim 2, further comprising:
a groove portion that is formed in the vehicle body panel and accommodates the flat routing member.
